(19) United States
(12) Patent Application Publication
(10) Pub. No.: US 2016/0149933 A1
(43) Pub. Date: May 26, 2016

(54) COLLABORATIVE NETWORK SECURITY

(71) Applicant: CANON KABUSHIKI KAISHA, Tokyo (JP)

(72) Inventors: Samuel Schrader, Irvine, CA (US); Allison Bajo, Carson, CA (US); Hari Rathod, Mission Viejo, CA (US)

(21) Appl. No.: 14/552,735

(22) Filed: Nov. 25, 2014

(51) Int. Cl. H04L 29/06

(52) U.S. Cl. CPC H04L 63/1416; H04L 63/20

(57) ABSTRACT

Security is managed on a collaboration of plural computers that together define a trusted network environment. Each computer presents one or more real services and one or more spoof services which spoof real services on a subset of ports. At any one computer of the plural computers, unauthorized or suspicious activity from a device is detected at the subset of ports. A message is transmitted from the one computer to the plural computers on the network informing of the activity. In response to receiving one or more messages pertaining to the device, each computer individually changes its access rules to block the device.

### FIELD

The present disclosure relates to collaborative network security, and more particularly relates to collaboration between multiple computers on a network to detect and respond to unauthorized usage or attacks on the network.

### BACKGROUND

In the field of network security, it is common to identify or detect suspicious activity on a network, in order to protect the network from malicious actions at one or more computers on the network.

One approach previously considered involves “honeypots”, which trap attackers by pretending to have legitimate services. For example, a honeypot may be a network site that appears to be part of a network and seems to contain a resource of value to attackers, but is actually isolated and monitored. Thus, when an attacker attempts to access the honeypot, the intrusion can be detected and blocked or otherwise dealt with.

Another approach involves “signature-based” intrusion detection and prevention systems. These systems rely on identifying suspicious or malicious attack patterns known as signatures. For example, a signature-based system might monitor packets on the network and compare them against a database of signatures or attributes from known malicious threats.

### SUMMARY

One difficulty with the honeypot or honeynet approach is that it relies on the attacker to attack a particular node, namely, the honeypot (or in the case of a honeynet, one of the honeypots). Meanwhile, signature-based approaches have difficulties arising from the fact that they rely on signatures to detect attacks. Thus, the network can be vulnerable to attacks which do not match known signatures.

The foregoing situation is addressed by providing spoof services on a subset of ports of every computer on a trusted network environment, and informing the network when unauthorized or suspicious activity is detected at any such ports.

Thus, in an example embodiment described herein, security is managed on a collaboration of plural computers that together define a trusted network environment. Each computer presents one or more real services and one or more spoof services which spoof real services on a subset of ports. At any one computer of the plural computers, unauthorized or suspicious activity from a device is detected at the subset of ports. A message is transmitted from the one computer to the plural computers on the network informing of the activity. In response to receiving one or more messages pertaining to the device, each computer individually changes its access rules to block the device.

By providing spoof services on a subset of ports of every computer on a trusted network environment and informing the network when unauthorized or suspicious activity is detected at any such ports, it is ordinarily possible for every computer on the network to detect and respond to threats on the network, even if the threat is new or unknown.

In one example aspect, the one computer determines that the activity is unauthorized or suspicious in a case that the device attempts to connect to a port of the subset of ports.

According to another example aspect, the one computer determines that the activity is unauthorized or suspicious in a case that the device attempts to probe a port of the subset of ports more than a threshold number of times.

In still another example aspect, each computer locally aggregates the message with other messages informing of unauthorized or suspicious activity, and changes access rules pertaining to the device according to a local threshold for unauthorized or suspicious activity. According to yet another example aspect, different computers on the network have different thresholds.

In another example aspect, the identities of the ports comprising the subset of ports are reconfigurable.

In yet another example aspect, the message is provided to a notification service.

In another example aspect, the one or more spoof services respond to the device with spoof data which is similar to a response from a real service.

In still another example aspect, the message is broadcast from the one computer to the plural computers. In one example aspect, the broadcast is received at each plural computer directly from the one computer. In another example aspect, the broadcast is received at the plural computers indirectly from the one computer.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 illustrates an example environment in which aspects of the present disclosure may be practiced.

FIG. 2 is a detailed block diagram depicting an example of the internal architecture of each of the computers shown in FIG. 1 according to an example embodiment.

FIG. 3 illustrates a collaborative network defense module according to an example embodiment.

FIG. 4 is a flow diagram for explaining collaborative network defense according to an example embodiment.

FIG. 5 is a flow diagram for explaining a response to a communication in accordance with an example embodiment.

FIG. 6 is a flow diagram for explaining a response to a communication in accordance with another example embodiment.

FIG. 7 is a view for explaining detection and response to a network attack according to an example embodiment.

FIG. 8 is a view for explaining detection and response to a network attack according to another example embodiment.

### DETAILED DESCRIPTION

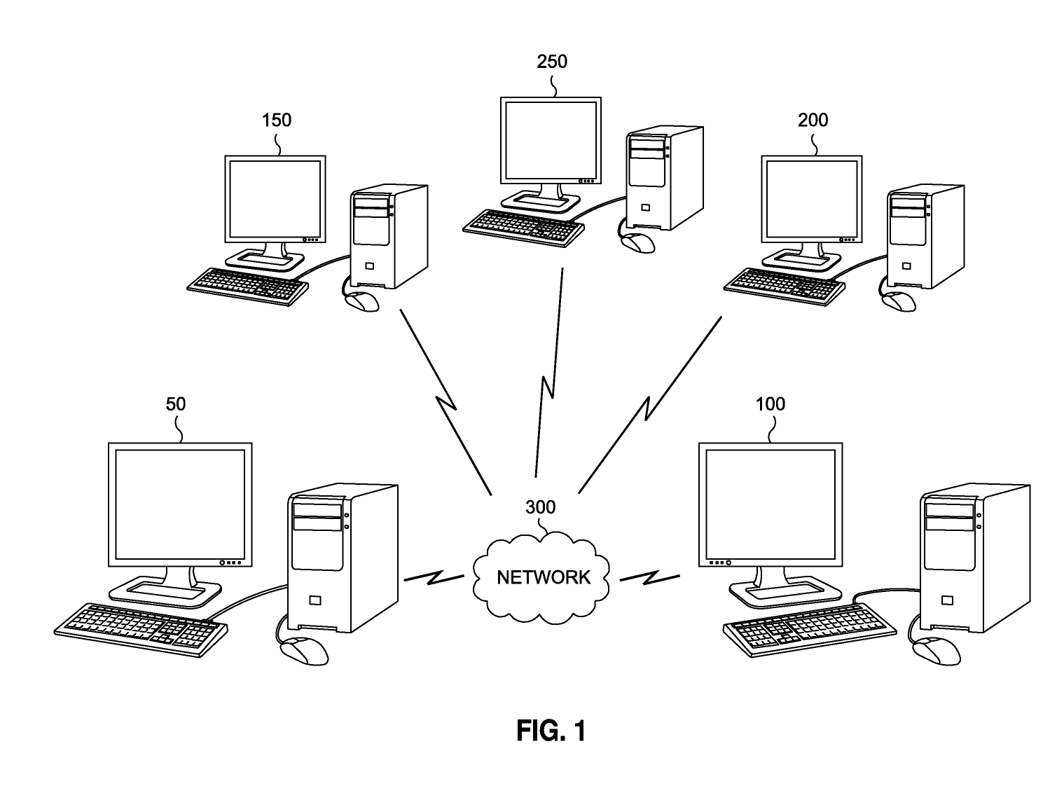

FIG. 1 illustrates an example environment in which aspects of the present disclosure may be practiced.

As shown in FIG. 1, computers 50, 100, 150, 200 and 250 are a collaboration of plural computers that together define a trusted network environment. While five computers are shown in FIG. 1 for purposes of simplicity, it should be understood that the number of computers and/or devices defining the trusted network environment may be any number greater than two. Moreover, while FIG. 1 depicts a computers 50, 100, 150, 200 and 250 as desktop computers, it should be understood that computing equipment or devices for practicing aspects of the present disclosure can be implemented in a variety of embodiments, such as a laptop, mobile phone, ultra-mobile computer, portable media player, game console, personal device assistant (PDA), netbook, or set-top box, among many others.

As defined herein, a “trusted network environment” includes a network of computers which have in some way confirmed that each computer of the network may be “trusted”. For example, each peer may be able to identify each other using a certificate, both for entry and for messaging between computers. Along the same lines, a public key/private key setup may be used. Other validation methods are possible, but for purposes of conciseness are not described herein in further detail.

As described more fully below, each computer or device in the trusted network environment implements spoof (i.e., fake) services alongside the real services provided by the computer. Thus, for example, computer 50 might present a fake database server to the network. Activity detected at ports corresponding to the spoof services can be labeled as suspicious, and dealt with accordingly via messaging across the network environment.

Each of computers 50, 100, 150, 200 and 250 generally comprise a programmable general purpose personal computer having an operating system, such as Microsoft® Windows® or Apple® Mac OS® or LINUX, and which is programmed as described below so as to perform particular functions and, in effect, become a special purpose computer when performing these functions.

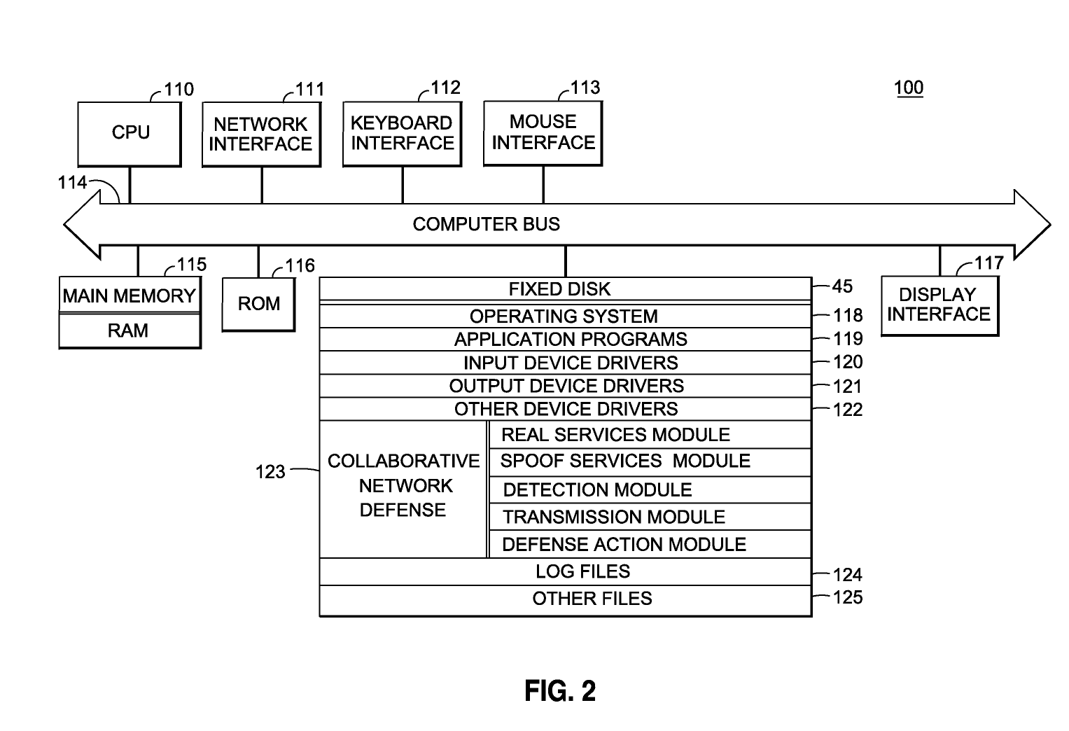

Each of computers 50, 100, 150, 200 and 250 includes computer-readable memory media, such as fixed disk 45 (shown in FIG. 2), which is constructed to store computer-readable information, such as computer-executable process steps or a computer-executable program for causing the computer to perform a method for managing security on the collaboration of plural computers that together define a trusted network environment, as described more fully below.

Network 300 transmits data between computers 50, 100, 150, 200 and 250. The implementation, scale and hardware of network 300 may vary according to different embodiments. Thus, for example, network 300 could be the Internet, a Local Area Network (LAN), Wide Area Network (WAN), Metropolitan Area Network (MAN), or Personal Area Network (PAN), among others. Network 300 can be wired or wireless, and can be implemented, for example, as an Optical fiber, Ethernet, or Wireless LAN network. In addition, the network topology of network 300 may vary.

FIG. 2 is a detailed block diagram depicting an example of the internal architecture of each of the computers shown in FIG. 1 according to an example embodiment. For purposes of conciseness, only the internal architecture of computer 100 is described below, but it should be understood that other computers 50, 100, 150, 200 and 250 or other devices may include similar components, albeit perhaps with differing capabilities.

As shown in FIG. 2, computer 100 includes central processing unit (CPU) 110 which interfaces with computer bus 114. Also interfacing with computer bus 114 are fixed disk 45 (e.g., a hard disk or other nonvolatile storage medium), network interface 111 for accessing other devices across network 300, keyboard interface 112, mouse interface 113, random access memory (RAM) 115 for use as a main run-time transient memory, read only memory (ROM) 116, and display interface 117 for a display screen or other output.

RAM 115 interfaces with computer bus 114 so as to provide information stored in RAM 115 to CPU 110 during execution of the instructions in software programs, such as an operating system, application programs, and device drivers. More specifically, CPU 110 first loads computer-executable process steps from fixed disk 45, or another storage device into a region of RAM 115. CPU 110 can then execute the stored process steps from RAM 115 in order to execute the loaded computer-executable process steps. Data, such as messages received on network 300, or other information, can be stored in RAM 115 so that the data can be accessed by CPU 110 during the execution of the computer-executable software programs, to the extent that such software programs have a need to access and/or modify the data.

As also shown in FIG. 2, fixed disk 45 contains computer-executable process steps for operating system 118, and application programs 119, such as display programs. Fixed disk 45 also contains computer-executable process steps for device drivers for software interface to devices, such as input device drivers 120, output device drivers 121, and other device drivers 122. Log files 124 may include a history of messages received on the network pertaining to suspicious activity from a device, as discussed more fully below. Other files 125 are available for output to output devices and for manipulation by application programs.

Collaborative network defense module 123 comprises computer-executable process steps for managing security on the collaboration of plural computers that together define the trusted network environment, and generally comprises a real services module, a spoof services module, a detection module, a transmission module, and a defense action module. More specifically, collaborative network defense module 123 is configured to provide spoof services on a subset of ports and inform the network when unauthorized or suspicious activity is detected at the subset of ports, and also to receive and respond to messages from other computers on the network regarding unauthorized or suspicious activity. These processes will be described in more detail below.

The computer-executable process steps for collaborative network defense module 123 may be configured as part of operating system 119, as part of an output device driver, such as a router driver, or as a stand-alone application program. Collaborative network defense module 123 may also be configured as a plug-in or dynamic link library (DLL) to the operating system, device driver or application program. It can be appreciated that the present disclosure is not limited to these embodiments and that the disclosed modules may be used in other environments.

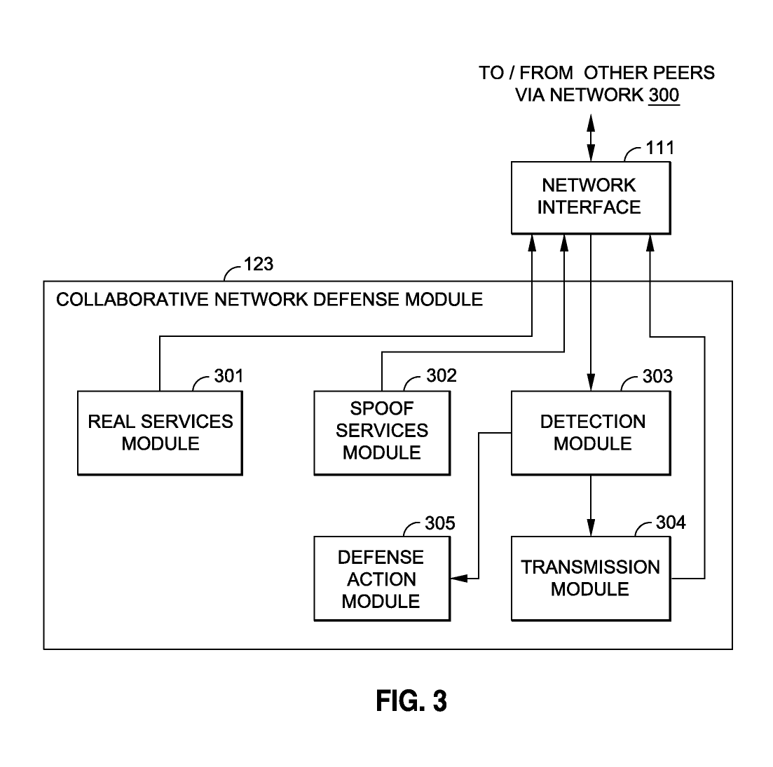

FIG. 3 illustrates a collaborative network defense module according to an example embodiment.

In particular, FIG. 3 illustrates example architecture of collaborative network defense module 123 in which the sub-modules of collaborative network defense module 123 are included in fixed disk 45. Each of the sub-modules are computer-executable software code or process steps executable by a processor, such as CPU 110, and are stored on a computer-readable storage medium, such as fixed disk 45 or RAM 115. More or less modules may be used, and other architectures are possible.

As shown in FIG. 3, collaborative network defense module 123 includes a real services module 301 for presenting one or more real services to the network, and spoof services module 302 for presenting (to the network) and one or more spoof services on a subset of ports. To that end, both real services module 301 and spoof services module 302 communicate via network interface 111 to reach other computers on network 300 (e.g., computers 50, 150, 200 and 250). Collaborative network defense module 123 also includes detection module 303 for detecting unauthorized or suspicious activity from a device at the subset of ports via, for example, network interface 111. Detection module 303 communicates with transmission module 304 to inform other peers of the unauthorized or suspicious activity, and with defense action module 305 to implement its own defense. For example, transmission module 304 transmits a message (via network interface 111) to the plural computers on the network informing of the activity, and defense action module 305, in response to receiving one or more messages pertaining to a device, individually access rules at the computer 100 to block the device.

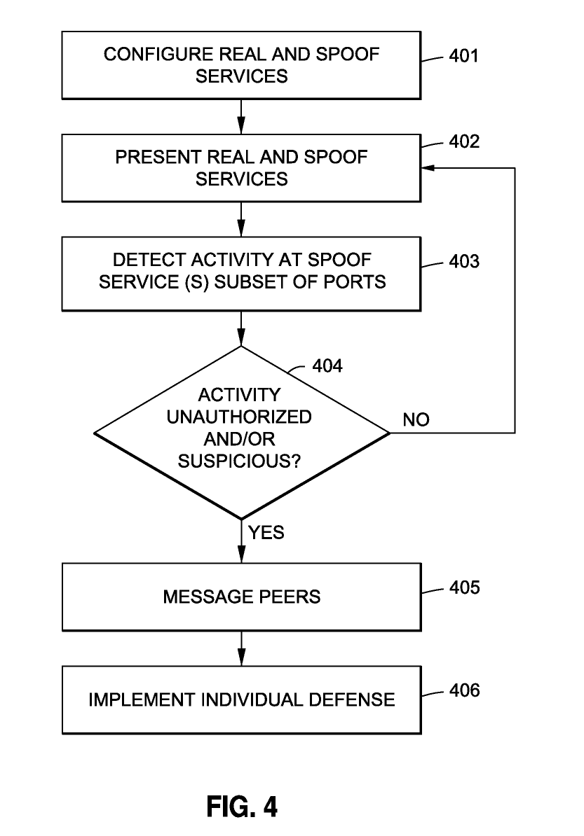

FIG. 4 is a flow diagram for explaining collaborative network defense according to an example embodiment.

Briefly, in FIG. 4, security is managed on a collaboration of plural computers that together define a trusted network environment. Each computer presents one or more real services and one or more spoof services which spoof real services on a subset of ports. At any one computer of the plural computers, unauthorized or suspicious activity from a device is detected at the subset of ports. A message is transmitted from the one computer to the plural computers on the network informing of the activity. In response to receiving one or more messages pertaining to the device, each computer individually changes its access rules to block the device.

In more detail, in step 401, real and spoof services are configured at each computer on the trusted network environment. Thus, real and spoof services are initiated and assigned to ports. In particular, the spoof services are assigned to a subset of ports which are monitored for suspicious activity.

In one example, the identities of the ports comprising the subset of ports are reconfigurable. In that regard, the reconfiguration can change which ports are used for spoof services, e.g., randomly setting which ports represent fake services. The reconfiguration can occur periodically, such as on a day to day basis. At the same time, spoof services may still be limited to known services for that port. For example, if a port is an HTTPS port, then the spoof services at that port may be limited to spoofing an HTTPS service. It should also be noted that each service is generally represented by a spoof service or a real service, but not both. Put another way, there generally will not be both spoof and real services at the same port.

Accordingly, the subset of ports can be changed to avoid or reduce the chance that attackers learn which ports are spoof ports. In some examples, the subset of ports may be different from so-called “well-known” ports which are commonly used for particular services (as shown in, for example, en.wikipedia.org/wiki/List_of TCP and UDP_port_numbers). In another example, well known services may be spoofed on the well-known ports. In still another example, the spoof services may be presented on all ports except the well-known ports.

By providing spoof and real services at each computer on the trusted network environment, the effects of common hacking techniques can be neutralized or minimalized. For example, often, an attacker may use a port scan (such as that described in www.nmap.org) to probe different ports of a target machine to see where to attack. However, according to the disclosure herein, the usefulness of such a scan is minimized or eliminated, since each computer is presenting multiple different services (real and fake) to the network, and is thereby active in defense. Thus, there is no way for a hacker to, for example, filter out known honeypots, since every computer is in some aspects a honeypot. Moreover, because of the number of services/ports, the simple act of performing the port scan will ordinarily take too long for a hacker to be able to complete such a scan (or do so before being caught).

In step 402, the real and spoof services are presented to the network. For example, each computer in the network (in production use or otherwise) presents any real services it is currently running on their assigned ports, along with presenting spoof services on another subset of ports. For example, a webserver may run legitimate services on ports 80 and 443, but also runs spoof services as defined above on a subset of its ports. In one embodiment, each computer is ignorant as to what services other computers are spoofing, and at what ports.

In step 403, activity is detected at the subset of ports corresponding to the spoof service(s). For example, a computer may detect a probe or request at the subset of ports where the spoof services are presented.

As described below, in some cases, any activity at the subset of ports may automatically be deemed suspicious and responded to, whereas in other cases, a threshold for multiple connections or certain types of connections may be implemented to allow for innocent but mistaken connection attempts to the subset of ports.

In step 404, there is a determination of whether the activity is unauthorized or suspicious. If the activity is not unauthorized or suspicious, the process returns to step 402 to continue presenting the real and spoof services. On the other hand, if the activity is unauthorized or suspicious, the process proceeds to step 405. In one example, the one computer determines that the activity is unauthorized or suspicious in a case that the device attempts to connect to a port of the subset of ports. Thus, any attempt to connect to the subset of ports of the spoof services is determined to be suspicious or unauthorized. In another example, the one computer determines that the activity is unauthorized or suspicious in a case that the device attempts to probe a port of the subset of ports more than a threshold number of times. This provides some leeway to account for innocent (but mistaken) connection attempts to the subset of ports, rather than immediately implementing a defense. In still another example, activity may be deemed suspicious when a computer attempts to access a port not characteristic of its former behavior or not explicitly allowed.

In step 405, a message is transmitted from the computer which detects the suspicious activity to the other computers on the trusted network environment. In one embodiment, the message is broadcast from the one computer to the plural computers. In one example, the message is received at each plural computer directly from the one computer, whereas in another example, the broadcast is received at the plural computers indirectly from the one computer (e.g., via other computers, the Internet, etc.). Therefore, collaboration may occur by allowing each network node (computer) to notify the other nodes and respond in agreement.

The message may include, for example, an identification of the device which is sending the message, the type of attack, the time when the attack happened, and the source of the attack.

In one example, all communication between nodes in the network happen over a secure TLS channel to prevent false notifications. In addition, all notifications broadcasted by a node may include a proof of the breach, and may be signed to prevent or reduce tampering.

In still another aspect, the message may be provided to a notification service in addition to being transmitted to the other computers. In particular, while the computers on the network may respond effectively to the threat as described below, it may nevertheless be useful for a user or administrator to be aware that such a threat has occurred. Therefore, in one embodiment, a notification service may be provided to communicate information about the suspicious or unauthorized activity, for example via a display or e-mail.

In step 406, each computer which receives the message implements an individual defense in response to receiving the message (or being the computer which transmitted it). In one example, each computer individually changes its access rules to block the device after receiving (or transmitting) the message. Accordingly, each computer acts individually, but the result is that the offending device is collectively banned from the network.

In one example, each computer immediately blocks a device which initiates suspicious activity. In another example, each computer locally aggregates the message with other messages informing of unauthorized or suspicious activity, and changes access rules pertaining to the device according to a local threshold for unauthorized or suspicious activity.

For example, a computer may store a history of messages concerning a particular device (e.g., log files 124), and change access rules to block the device after receiving a threshold number of messages that the device is acting suspiciously (e.g., after 2 messages). Put another way, each computer which receives a message identifies the source of the attack, and takes action depending on stored history regarding the source of the attack and on a local threshold for such activity. Of course, different computers may have different thresholds. In yet another aspect, when an attack is detected at a computer, the computer's history information may also be communicated in the message sent in step 405. Thus, each machine has its own list of intruders, which it can broadcast to all of the other machines on the trusted network environment.

Accordingly, the network of trusted computers may collectively refuse service to an aggressor. In some examples, the one or more spoof services respond to the device with spoof data which is similar to a response from a real service, so as to trick or delay the attacker while formulating or implementing a response. Thus, the computers may respond to the aggressor in such a way as to seem to show legitimate services, where in fact the services are all or largely fictitious for the purpose of misleading the aggressor. For example, responses which appear real may provide additional time for the network's owner time to respond, e.g., in a case where the owner expects be notified and to choose responses to such attacks. In one example, the computers may respond with fake data, real data, or some combination thereof.

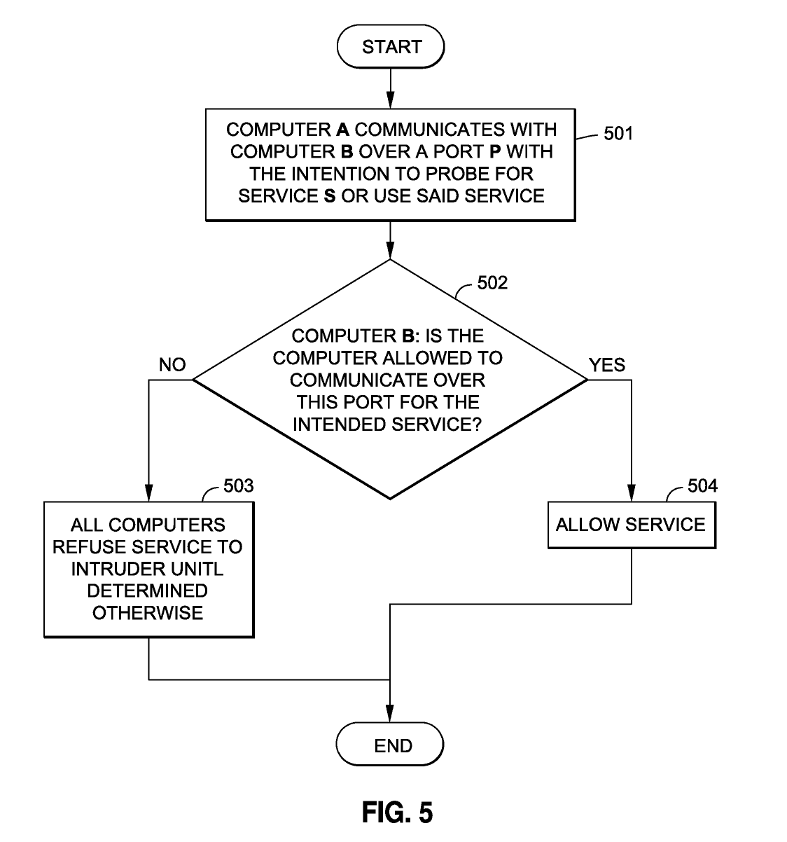

FIG. 5 is a flow diagram for explaining response to a communication in accordance with an example embodiment.

In step 501, a computer A communicates with a computer B over a port P, with the intention to probe for service S or use service S.

In step 502, there is a determination, at computer B, of whether the computer A is allowed to communicate over the port P for the intended service S. In one example, as described above, this depends on whether the port P is a port assigned to a spoof service, i.e., whether the port P is a member of the subset of ports corresponding to spoof services. In another example, the determination might include or be based on other conditions, such as whether the computer A has been previously allowed to use service S on port P, or whether computer A has ever communicated with port P before.

If computer A is not allowed to communicate over the port P for the intended service S, the process proceeds to step 503, where all computers on the network refuse service to the intruder (computer A) as discussed above, until determined otherwise.

On the other hand, if the computer A is allowed to communicate over port P for service S, the process proceeds to step 504, where access and usage of service S are allowed for computer A.

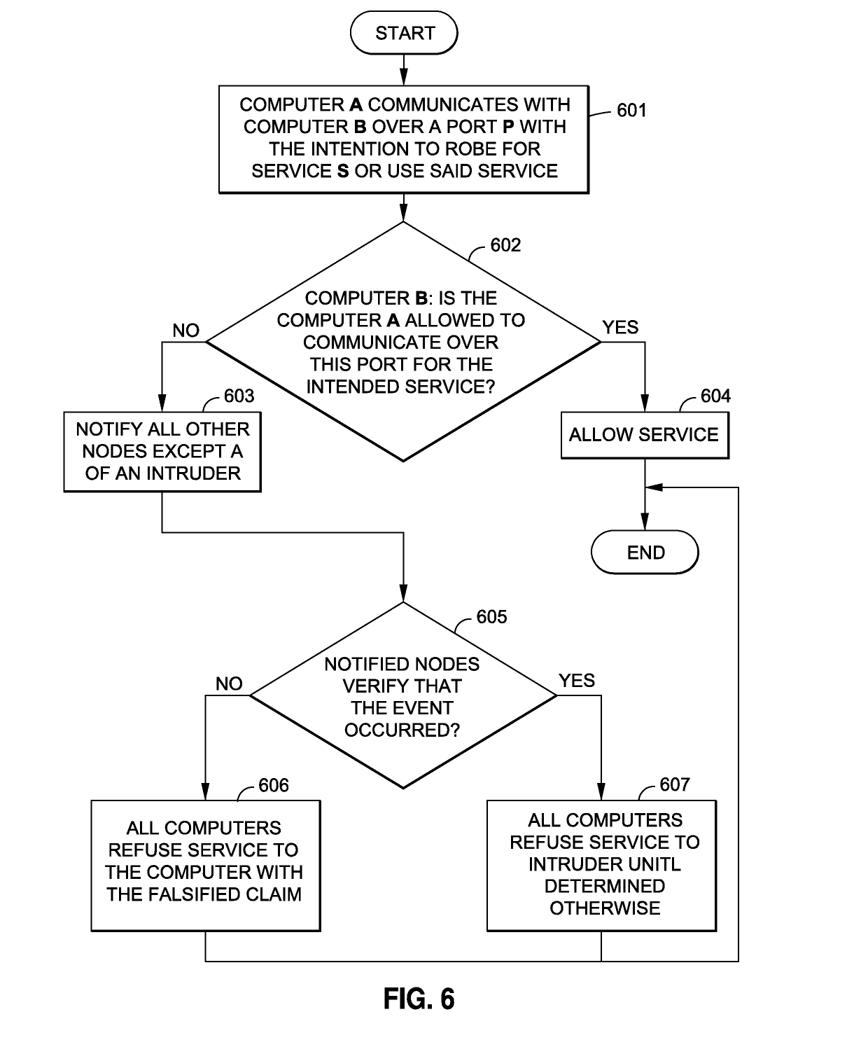

FIG. 6 is a flow diagram for explaining a response to a communication in accordance with another example embodiment. In particular, FIG. 6 addresses a situation in which a computer transmitting a message may be sending a falsified claim (i.e., may itself be compromised).

In step 601, a computer A communicates with a computer B over a port P, with the intention to probe for service S or use service S.

In step 602, there is a determination, at computer B, of whether the computer A is allowed to communicate over the port P for the intended service S. As described above, this can depend on whether the port P is a port assigned to a spoof service, i.e., whether the port P is a member of the subset of ports corresponding to spoof services. In another example, the determination might include or be based on other conditions, such as whether the computer A has been previously allowed to use service S on port P, or whether computer A has ever communicated with port P before.

If the computer A is allowed to communicate over port P for service S, the process proceeds to step 604, where access and usage of service S are allowed for computer A and the process ends.

If the computer A is not allowed to communicate over port P for service S, the process proceeds to step 603, where all nodes on the network except for computer A are notified of an intruder on the network.

In step 605, there is a determination of whether the computers have verified that the event occurred, for example by examining messages from computer B and/or verifying that computer B is still on the trusted network. If not, the process proceeds to step 606, where all computers refuse service to the computer with the falsified claim (computer B). On the other hand, if the event is verified, the process proceeds to step 607, where all computers on the network refuse service to the intruder (computer A) as discussed above, until determined otherwise.

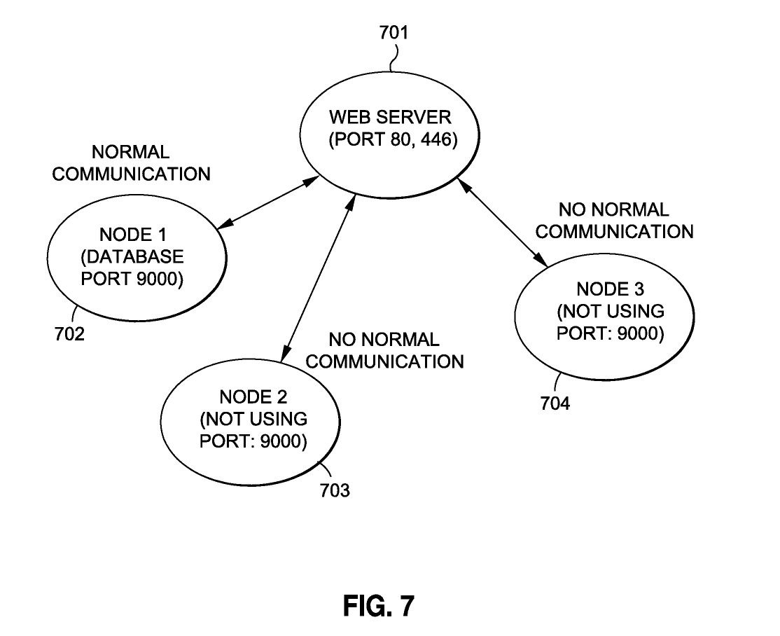

FIG. 7 is a view for explaining detection and response to a network attack according to an example embodiment.

As shown in FIG. 7, a webserver 701 commonly communicates with a database node 702 over port 9000 (a common database port), but does not communicate with nodes 703 or 704 via this port. Should the web server 701 be compromised and attempt to contact node 703 or node 704 about a database service on port 9000, the network will immediately “know” it has been compromised and respond, using the processes outlined above.

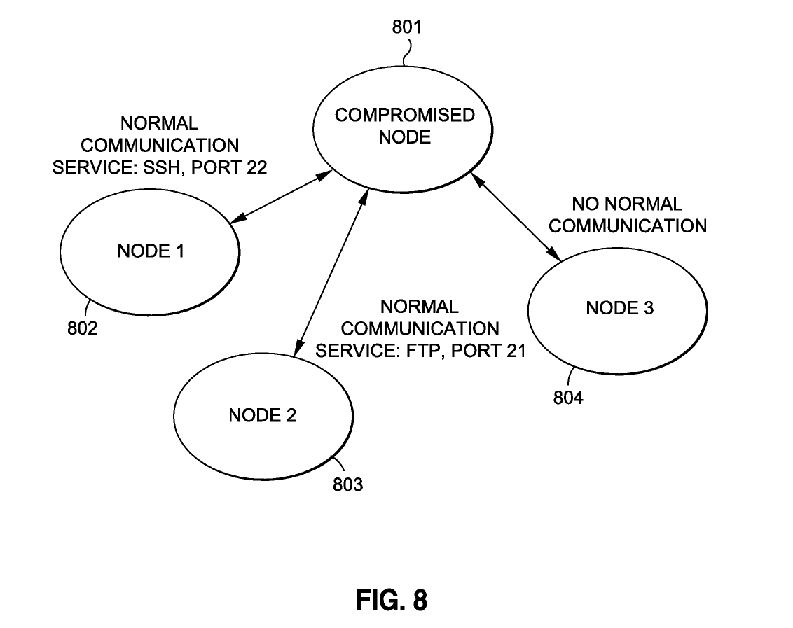

FIG. 8 is a view for explaining detection and response to a network attack according to another example embodiment.

As shown in FIG. 8, an internal computer in the network (the compromised node 801) commonly communicates to node 802 over SSH and node 803 over FTP. Should the compromised node 801 attempt to scan for or use any service that it has not been authorized to use or communicate with (e.g., node 804), the network immediately becomes aware that the node 801 has been compromised and responds accordingly.

### Other Embodiments

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for managing security on a collaboration of plural computers that together define a trusted network environment, the method comprising:
presenting, at each computer, one or more real services and one or more spoof services which spoof real services on a subset of ports;
detecting, at any one computer of the plural computers, unauthorized or suspicious activity from a device at the subset of ports; and
transmitting a message from the one computer to the plural computers on the network informing of the activity,
wherein in response to receiving one or more messages pertaining to the device, each computer individually changes its access rules to block the device.

2. The method according to claim 1, wherein the one computer determines that the activity is unauthorized or suspicious in a case that the device attempts to connect to a port of the subset of ports.

3. The method according to claim 1, wherein the one computer determines that the activity is unauthorized or suspicious in a case that the device attempts to probe a port of the subset of ports more than a threshold number of times.

4. The method according to claim 1, wherein each computer locally aggregates the message with other messages informing of unauthorized or suspicious activity, and based on a local threshold for unauthorized or suspicious activity, changes access rules pertaining to the device and/or responds to the device with false data.

5. The method according to claim 1, wherein the identities of the ports comprising the subset of ports are reconfigurable.

6. The method according to claim 1, wherein the message is provided to a notification service.

7. The method according to claim 1, wherein the one or more spoof services respond to the device with spoof data which is similar to a response from a real service.

8. The method according to claim 1, wherein the message is broadcast from the one computer to the plural computers.

9. The method according to claim 8, wherein the broadcast is received at each plural computer directly from the one computer.

10. The method according to claim 8, wherein the broadcast is received at the plural computers indirectly from the one computer.

11. A computer for managing security on a collaboration of plural computers that together define a trusted network environment, comprising:
a computer-readable memory constructed to store computer-executable process steps; and
a processor constructed to execute the process steps stored in the memory,
wherein the process steps cause the processor to:
present one or more real services and one or more spoof services which spoof real services on a subset of ports;
detect unauthorized or suspicious activity from a device at the subset of ports; and
transmit a message to the plural computers on the network informing of the activity,
wherein each computer of the plural computers presents a respective set of one or more real services and one or more spoof services, and detects unauthorized or suspicious activity from a device at the subset of ports, and
wherein in response to receiving one or more messages pertaining to the device, each computer individually changes its access rules to block the device.

12. The computer according to claim 11, wherein the activity is determined as unauthorized or suspicious in a case that the device attempts to connect to a port of the subset of ports.

13. The computer according to claim 11, wherein the activity is determined as unauthorized or suspicious in a case that the device attempts to probe a port of the subset of ports more than a threshold number of times.

14. The computer according to claim 11, wherein each computer of the plural computers locally aggregates the message with other messages informing of unauthorized or suspicious activity, and based on a local threshold for unauthorized or suspicious activity, changes access rules pertaining to the device and/or responds to the device with false data.

15. The computer according to claim 11, wherein the identities of the ports comprising the subset of ports are reconfigurable.

16. The computer according to claim 11, wherein the message is provided to a notification service.

17. The computer according to claim 11, wherein the one or more spoof services respond to the device with spoof data which is similar to a response from a real service.

18. The computer according to claim 11, wherein the message is broadcast from the one computer to the plural computers.

19. The computer according to claim 18, wherein the broadcast is received at each plural computer directly from the one computer.

20. A non-transitory computer-readable storage medium storing computer-executable process steps for causing a computer to perform a method for on a collaboration of plural computers that together define a trusted network environment, the method comprising:
presenting one or more real services and one or more spoof services which spoof real services on a subset of ports;
detecting unauthorized or suspicious activity from a device at the subset of ports; and
transmitting a message to the plural computers on the network informing of the activity,
wherein each computer of the plural computers presents a respective set of one or more real services and one or more spoof services, and detects unauthorized or suspicious activity from a device at the subset of ports, and
wherein in response to receiving one or more messages pertaining to the device, each computer individually changes its access rules to block the device.
